(19) United States
(12) Patent Application Publication
(10) Pub. No.: US 2009/0202968 A1
(43) Pub. Date: Aug. 13, 2009

(54) Systems and Methods for Combining Electronic Educational and Entertainment Media

(75) Inventor: Stephen Russell Falcon, Woodinville, WA (US)

Correspondence Address: Steve Falcon, 15802 Saybrook Dr. NE, Woodinville, WA, 98077, US

(73) Assignee: POPSPRING LLC, Woodinville, WA (US)

(21) Appl. No.: 12/371,303

(22) Filed: Feb. 13, 2009

Related U.S. Application Data
(60) Provisional application No. 61/028,193, filed on Feb. 13, 2008.

(51) Int. Cl. G09B 7/00

(52) U.S. Cl. 434/323

(57) ABSTRACT

In accordance with one aspect, electronic visual media is deemed by the user as interruptible or not interruptible. In accordance with another aspect, a timer determines when to interrupt interruptible media. In another aspect, media is interrupted by educational media comprising a question that is subsequently answered by a user. In another aspect, a correct response triggers dismissal of the interrupting question whereas an incorrect answer does not. In another aspect, correctly answering multiple questions in series accumulates time credit that delays further interruption of media.

### NON-PROVISIONAL CONTINUATION

This application is a non-provisional continuation of provisional patent application No. 61/028,193, entitled Systems And Methods For Delivering Educational Content In Conjunction with Electronic Entertainment.

### TECHNICAL FIELD

The systems and methods described herein relate to combining electronic educational instruction with other electronic media technology. More specifically, the described invention relates to systems and methods for teaching information and skills to individuals while they are interacting with entertainment media or software such as video, video games, computer games and web sites, using personal computer systems, video game consoles, portable electronic game devices, video players, or portable video players.

### BACKGROUND

Society's vast range of entertainment media in the form of video, video games, computer games and web sites provides a seemingly endless means of preoccupying people of all ages. Moreover, many people engaged in the consumption of such entertainment media often do so at the exclusion other worthwhile activities. For instance, whereas modern parents may find it difficult to motivate their school-aged children to study, they note their children's insatiable desire to play video games, watch TV or video, browse the web, and otherwise consume digital entertainment. Many parents try to limit the extent to which their children consume such entertainment for fear that it robs them of other valuable life experiences and learning, both practical and academic.

As a remedy to this situation, many parents cater to their children's desire for electronic entertainment by providing educational computer software, video games and web sites that provide academic value in somewhat entertaining ways. However, such educational media often proves less entertaining to its audience than does purely recreational material, and therefore, parents find that such educational material does not hold their children's interest effectively.

Since entertainment media is generally more effective at captivating its audience than educational media, significant benefit could be derived if educational media could instead be delivered in conjunction with preexisting entertainment media. By exploiting the captivating nature of existing entertainment media such as video, video games, computer games and web sites, educational material may be delivered and learned by individuals who might not otherwise learn it timely, or perhaps ever.

### SUMMARY

Systems and methods are described for combining the presentation of educational and entertainment media together in a visual media system such as a personal computer system, video game console, portable electronic game device, video player, or portable video player. In one or more implementations, the interruption of entertainment media by educational media is described in the context of the exemplary system.

The system identifies times when it is necessary to trigger evaluation of the currently displayed media, and determines if it should be interrupted with educational media. Upon such triggering, the system identifies the currently active media and determines if it should be interrupted according to lists of interruptible and non-interruptible media titles and computer process executable file names. The system then triggers presentation of educational media when the currently displayed media is determined to be interruptible.

The educational media is composed by the system as an interactive question, and the question is presented upon interruption. The content of the question is optionally tailored to the interests and capabilities of the user. The interrupting media may not be dismissed by the user until the contained question is answered correctly. The system monitors the user's response to the question and records whether the question was answer correctly, and if so, whether it was answered correctly on the user's first try.

The user may optionally choose to correctly answer a series of interactive questions without delay, in order to accumulate time credit that forestalls the inevitable automatic interruption of entertainment media.

### BRIEF DESCRIPTION OF THE DRAWINGS

A more complete understanding of exemplary methods and arrangements may be had by referring to the following detailed description in conjunction with the accompanying drawings:

FIG. 1 depicts exemplary computer monitors that display exemplary user interface windows.

FIG. 2 depicts exemplary media lists and user options for identifying interruptible media.

FIG. 3 depicts an exemplary educational window interrupting an exemplary entertainment window.

FIG. 4 is a flowchart illustrating an exemplary process for determining whether to interrupt.

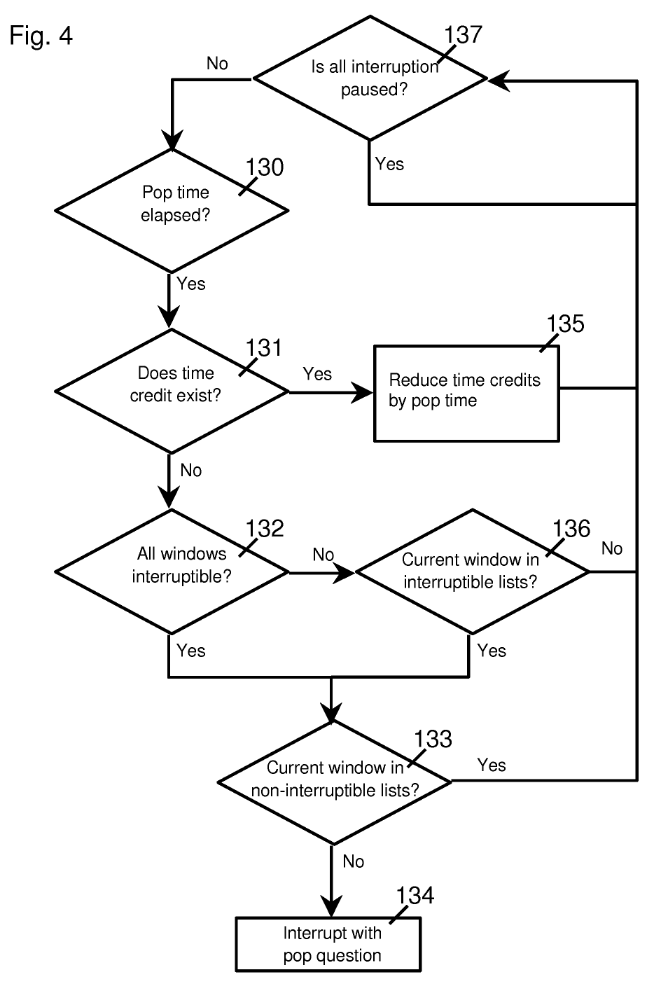

FIG. 5 is a flowchart depicting an exemplary process for determining whether a window is referenced by a list.

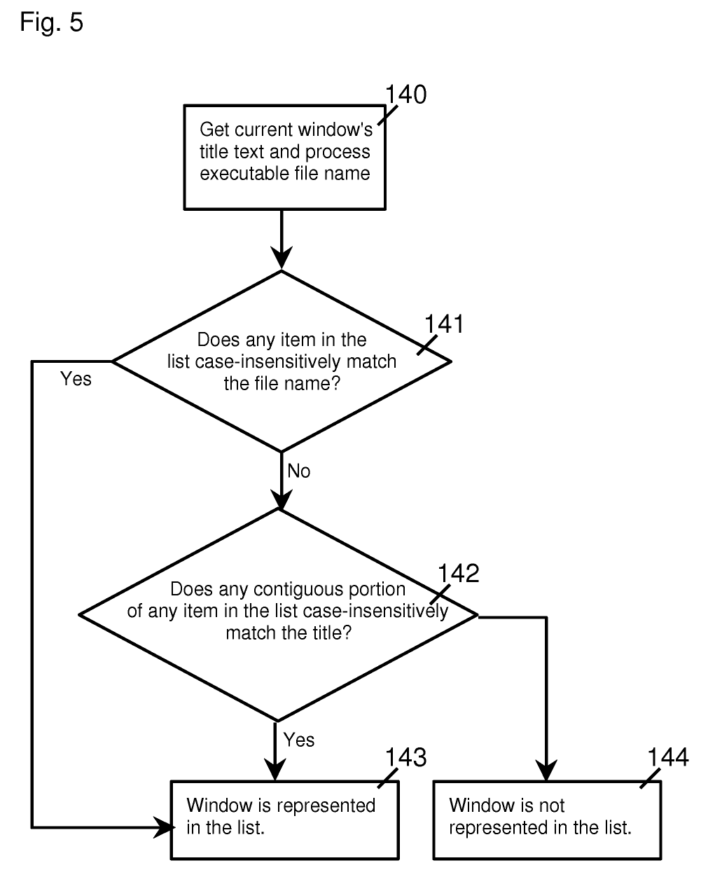

FIG. 6 is a flowchart depicting an exemplary process for identifying the current media.

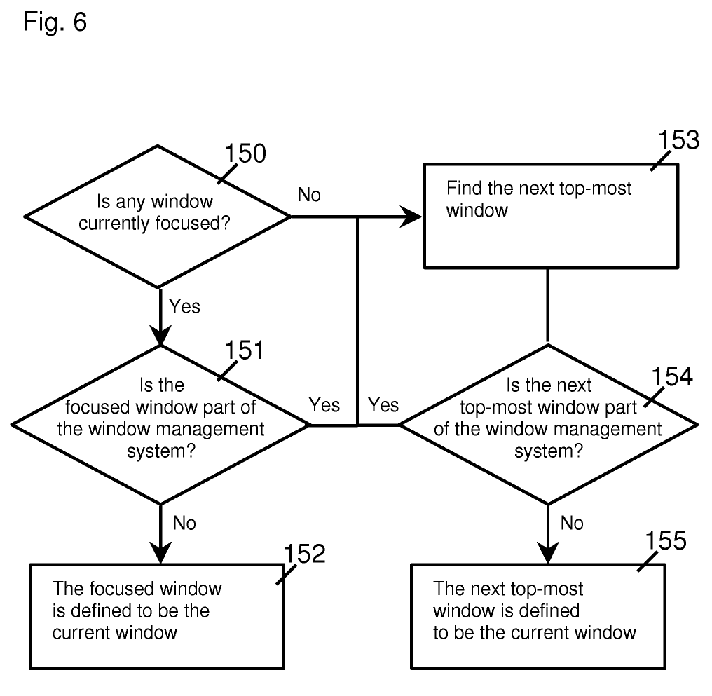

FIG. 7 is a flowchart depicting an exemplary process for determining how interrupting media is dismissed

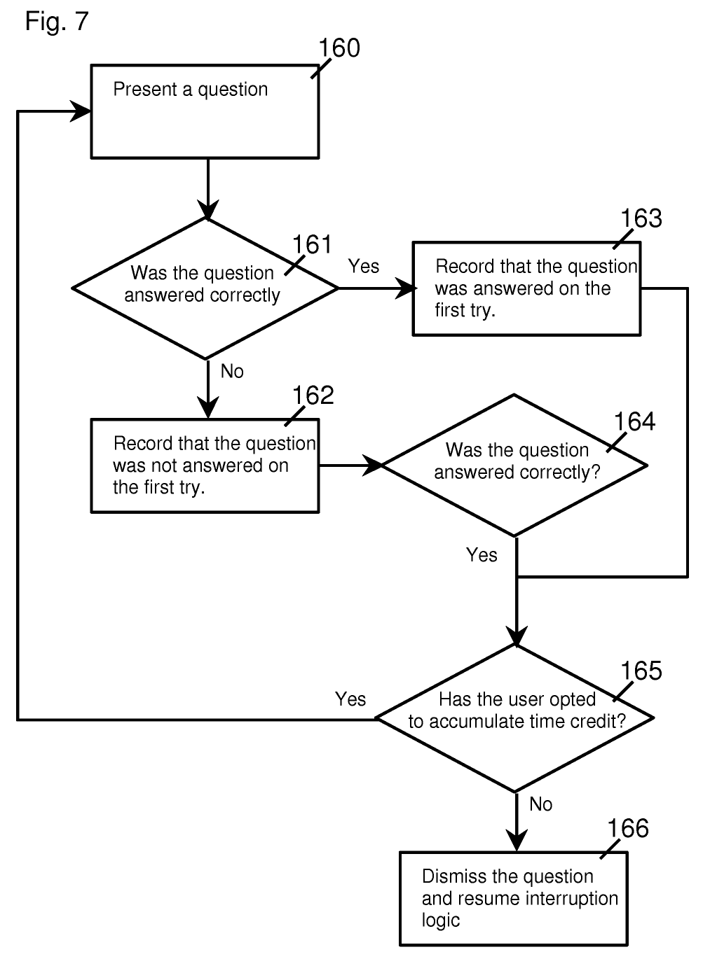

FIG. 8 is a mixed diagram depicting an exemplary process of interrupting interruptible media, and not interrupting non-interruptible media.

### DETAILED DESCRIPTION

Combining electronic educational and entertainment media is described herein. This invention concerns systems that display electronic visual media. The invention may at times be described according to an implementation involving a personal computer. However, it is noted that the methods described herein may be applied to other systems such as videogame consoles, video players, personal media players, televisions, portable game players and other devices that display electronic media such as videos, video games, web pages, computer games, and other visual media. The invention relates to presenting educational media in conjunction with other visual media.

### Computer-Executable Instructions

The invention is implemented as computer-executable instructions in a suitable computing or digital media environment. Although not required, the invention is described in the context of computer-executed instructions to be executed by a computing device such as a personal computer. Executed instructions include program modules, objects, procedures, data structures, windows, lists, dialog boxes, etc, that perform particular tasks. Those skilled in the art will understand that the invention may be implemented with various digital system and configurations such as videogame consoles, portable media players and game devices, video players and digital television, etc.

### Overview

For the purposes of description a window is defined as a visual presentation of electronic media as in the case of exemplary Microsoft Windows, Apple Mac or similar computer system graphical user interface windows.

A pop question is defined as the presentation of an interrupting window, for the purpose of providing an educational media experience to the user.

The current window is defined as the currently focused window, or the top-most window, excluding windows that are part of a menu or operating system, such as the Microsoft Windows Start menu, that function for the purpose of managing the execution or display of other windows.

An interruptible window is a window that has been deemed a target of interruption by pop questions.

A non-interruptible window is a window that has been deemed not a target of interruption by pop questions.

An interruptible window list is a visible or invisible data structure containing window titles and process executable file names representing windows that are subject to interruption.

A non-interruptible window list is a visible or invisible data structure containing window titles and process executable file names representing windows that are not subject to interruption.

Pop time is a time interval upon which successive pop questions may interrupt interruptible windows.

Time credit is a time delay during which pop questions are not triggered regardless of the currency of an interruptible window.

### Methods

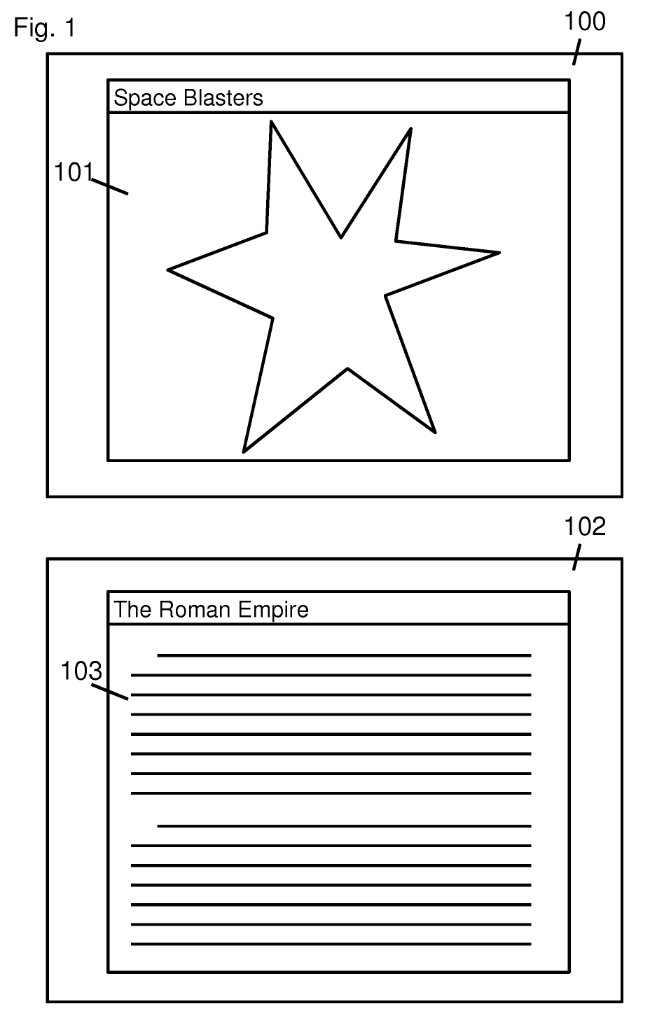

FIG. 1 is a diagram of computer display 100 displaying window 101 comprising exemplary interruptible media, and window 102 comprising exemplary non-interruptible media.

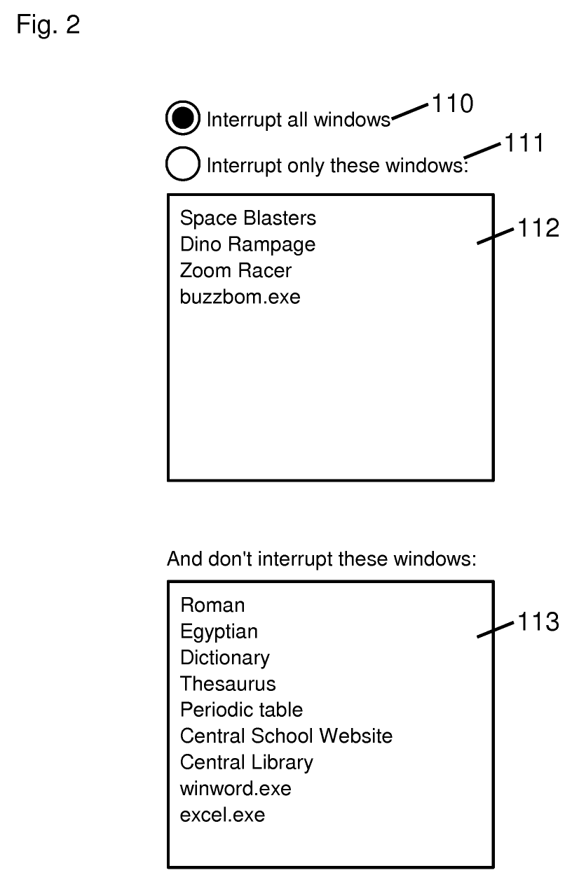

FIG. 2 is a diagram of option 110 selected by the user to target all windows for interruption except those represented by the items in the non-interruptible window list 113. The alternative option 111, if selected, signifies that only the windows represented by items in the interruptible windows list 112 will be targeted for interruption.

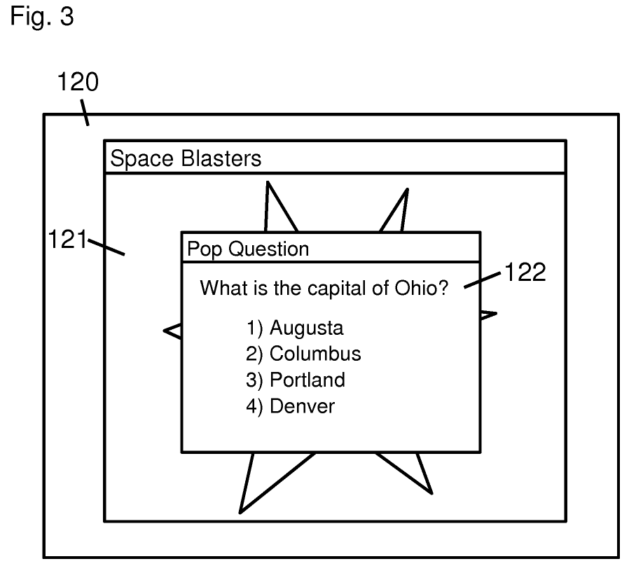

FIG. 3 is a diagram of a computer display 120 displaying interruptible window 121 interrupted by pop question window 122.

If all interruption is not paused 137, if the pop time 130 has elapsed, the system checks whether any time credit exists 131. If time credit exists 131, the system deducts the current pop time from the total time credit 135 and determines whether all interruption is now paused 137. If time credit does not exist 131, the system checks whether the user has opted to interrupt all windows 132. If the user has not opted to interrupt all windows 132, the system checks whether the current window is represented by an item in the interruptible windows list 136. If the current window is not contained in the interruptible windows list 136, the system returns to determines whether all interruption is now paused 137. If either the user has opted to interrupt all windows 132, or the current window is contained in the interruptible media list 136, then the system checks whether the current window is contained in the non-interruptible media list 133. If the current window is contained in the non-interruptible media list 133, then the system returns to determines whether all interruption is now paused 137. If the current window is not contained in the non-interruptible media list 133, then the system displays a pop question 134,122.

When determining whether the current window is contained in the interruptible windows list or the non-interruptible media list, the system first gets the current window's title text and process executable file name 140. The system then checks whether any item in the list case-insensitively matches the current window's executable file name 141. If there is such a match, the window has been determined to be contained in the list. If there is no such match, the system then checks whether any contiguous portion of any item in the list case-insensitively matches the current window's title text. If there is such a match, the window has been determined to be represented in the list. If there is no such match the window has been finally determined to not be represented in the list. Note that this implementation is exemplary. Those skilled in the art realize that other methods or orders of logical execution can produce the same unique result.

When determining which window is the current window, if any window is currently focused 150, the system checks whether the focused window is part of the systems window management system 151. If no window is currently focused 150, the system checks the next top-most window 153. If the focused window is not a part of the window management system 151, the focused window is defined as the current window 152. If the focused window is part of the window management system 151, the system finds the next top-most window 153. If that window is part of the window management system 154, the system finds the next top-most window, and so on. Once the next top-most window is not part of the window management system, 154, then that window is defined as the current window. If no windows exist or all windows are part of the window management system then no window is defined as the current window.

When determining whether to dismiss an interrupting question 160, if the question was answered correctly on the first try 161, the system records that the question was answered correctly on the first try 163. If the question was not answered correctly on the first try 161, then the system records that the question was not answered correctly on the first try 162. One the user finally answers the question correctly 164, if the user has opted to accumulate time credit 165, the system presents another question 160. If the user has not opted to accumulate time credit 165, then the question window is dismissed 166.

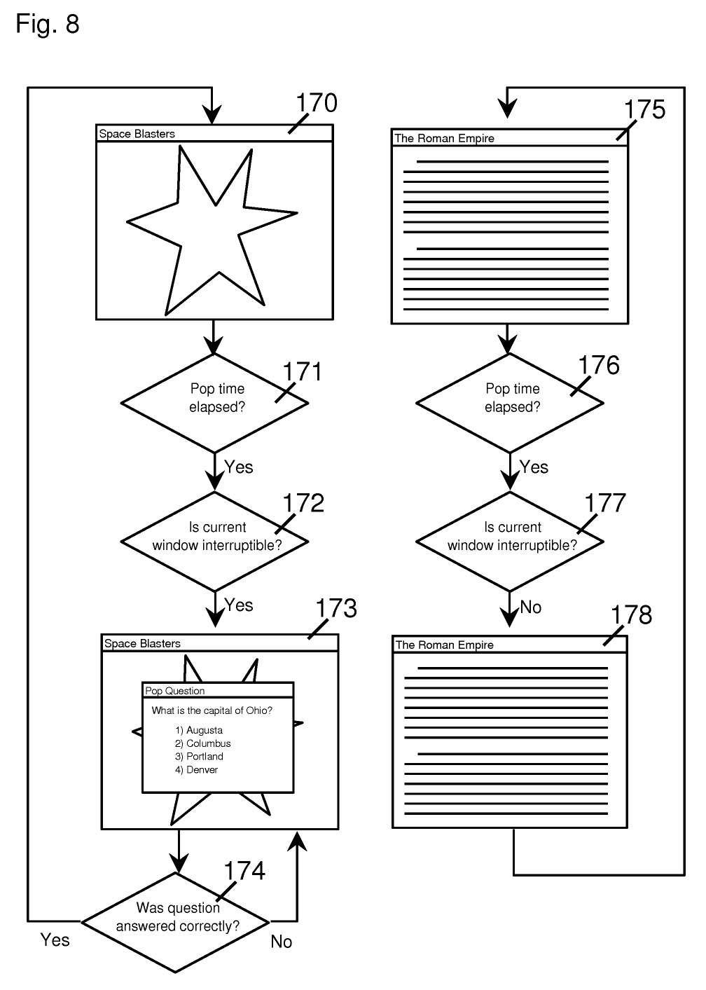

FIG. 8 illustrates alternate scenarios where in one case a window has been designated as interruptible, and in the other case a window has been designated as non-interruptible. Window 170 is designated as interruptible. When pop time has elapsed 171, since the current window is interruptible 172, a pop question window interrupts and displays on top of the interruptible window 173. If the user has not answered the question or the user has incorrectly answered the question 174, the pop question window remains and blocks the interruptible window 173. When the user correctly answers the question 174, the pop question window is dismissed and the interruptible window 170 is revealed.

Alternatively, window 175 is designated as non-interruptible. When pop time has elapsed 176, since the current window is non-interruptible 177, the window is not interrupted 178. The non-interruptible window remains 175 until the process repeats.

### CONCLUSION

The systems and methods as described provide a way to combine educational electronic media with electronic entertainment media.

Although the above describes specific implementation details and embodiments, such details are meant to satisfy statutory disclosure obligations rather than to limit the scope of the appended claims. The invention defined by the appended claims is not limited to the description above. Rather, the invention is claimed in any forms or modifications that lie within the scope of the appropriately interpreted claims.

The invention claimed is:

1. A method for combining the presentation of educational and entertainment media in an electronic media system comprising determining when to interrupt presentation of media with the presentation of educational media; identifying whether certain media is to be interrupted by educational media; interrupting media repeatedly by the presentation of educational media; and resuming presentation of interrupted media after dismissal of interrupting educational media.

2. The method recited in claim 1, wherein the entertainment media comprises a window in a computer graphical user interface.

3. The method recited in claim 1, wherein determining when to commence repeatedly interrupting media comprises a delay timer that triggers such commencement; and determining when to repeat interruption comprises a repetition timer that triggers such repeated interruptions.

4. The method recited in claim 3 wherein the delay timer's duration is set by the user via a user interface.

5. The method recited in claim 3 wherein the repetition timer's time interval is set by the user via a user interface.

6. The method recited in claim 3 wherein the delay and repetition timers are paused by the user via a user interface.

7. The method recited in claim 1 wherein identifying whether to interrupt the current media is by determining if all media or the current media was classified as interruptible by the user; and the current media was not classified as non-interruptible by the user.

8. The method recited in claim 7 wherein determining if the current media was classified as interruptible or non-interruptible comprises determining if the media's title text case-insensitively matches an item or a contiguous portion of an item in a list of interruptible and non-interruptible title text texts.

9. The method recited in claim 8 wherein the media title text comprises the title of a window in a computer graphical user interface.

10. The method recited in claim 8 wherein the media title text comprises the title, genre or channel of a live or prerecorded television program.

11. The method recited in claim 8 wherein the media title text comprises the title of a console or portable video game.

12. The method recited in claim 8 wherein the media title text comprises the title or genre of a recorded video program.

13. The method recited in claim 8 wherein the media title text comprises the title, URL, or domain name of a web page.

14. The method recited in claim 7 wherein classifying the current media as interruptible or non-interruptible optionally comprises determining if the media's process executable file name case-insensitively matches an item in a list of interruptible and non-interruptible process executable file names.

15. The method recited in claim 1 wherein the educational media comprises one or more questions that the user can interactively answer correctly or incorrectly.

16. The method recited in claim 15 wherein the user not answering a question or the user incorrectly answering a question prevents dismissal of the interrupting media.

17. The method recited in claim 15 wherein the user correctly answering a question triggers dismissal of the interrupting media.

18. The method recited in claim 15 wherein the user correctly answering a question triggers increasing the duration of an interruption delay timer.

19. The method recited in claim 15 wherein the user incorrectly answering a question triggers storing a record that the question was incorrectly answered; and the user correctly answering a question before having answered incorrectly within the given interruption triggers storing a record that the question was answered correctly on the first try.

20. The method recited in claim 19 wherein the system displays a numeric figure representing the ratio of times that the user answered a question or group of questions on the first try, to the number of total times that the user answered the question or group of questions.
